(19) United States
(12) Patent Application Publication
(10) Pub. No.: US 2016/0376841 A1
(43) Pub. Date: Dec. 29, 2016

(54) ROLL UP DOOR ASSEMBLY

(71) Applicant: PERFORMAX GLOBAL, Aston, PA (US)

(72) Inventor: Dirk Hentschel, Soligen (DE)

(21) Appl. No.: 15/193,346

(22) Filed: Jun. 27, 2016

Related U.S. Application Data
(60) Provisional application No. 62/185,177, filed on Jun. 26, 2015.

(51) Int. Cl. E06B 9/58; E06B 9/13

(52) U.S. Cl. CPC E06B 9/581; E06B 9/13; E06B 2009/585

(57) ABSTRACT

Disclosed is a low cost highly dependable roll up door assembly that resists impacts and allows for quick and easy reinsertion of the door into the guide tracks if the door is removed from the tracks. The roll up door has tracks made of c shaped metal channels that are connected together to from the longitudinal opening for receipt of the door. The edges of the sides of the longitudinal opening are bent to form a generally u-shaped edge or a rail is added to the exposed edges to facilitate release of the locks from the tracks in the event of an impact.

### RELATED APPLICATIONS

This application claims the benefit of U.S. Provisional Application No. 62/185,177 filed on Jun. 26, 2015.

### STATEMENT REGARDING FEDERALLY SPONSORED RESEARCH

None.

### TECHNICAL FIELD

This invention relates generally to roll up doors for use in opening and closing for example a factory loading bay door. Even more particularly the present invention relates to rubber roll up doors and in particular; rubber roll up doors that can withstand a large impact without damage to the door or the tracks in which the door is guided.

### BACKGROUND OF THE INVENTION

Roll up doors are commonly used in commercial buildings to allow entry ways, such as loading bays, to be opened and closed. Typical roll up doors are made of aluminum. However, rubber roll up doors are now replacing aluminum doors. One of the main reasons for this is that rubber doors can withstand inadvertent impacts better than aluminum doors.

At a minimum, aluminum doors when impacted will have an unsightly dent and worst case be destroyed requiring a complete reinstallation of not only the door but the door tracks as well as possibly the surrounding building structure. Due to the environment in which rollup doors are typically used, there is a high likelihood of repetitive inadvertent impacts with the doors. For example, fork lift drivers or truck drivers, etc. can inadvertently impact a door. One problem with inadvertent impacts to aluminum doors is the resultant unsightly appearance of the door. But more problematic is the impact which results in the door being inoperable. If an aluminum door is impacted and its locks or guide wheels are dislodged from the guiding tracks, it is a very difficult task to straighten the door and reinsert the guide wheels in the guide track. In some instances, the door cannot be reinserted into the tracks and a new door has to be purchased and installed. Even more problematic is when the impact results in the tracks being bent or even pulled out of the supporting structure. This requires not only the replacement of the door, but also the tracks and even in some instances the repair of the building structure. This can result in considerable costs and downtime.

U.S. Pat. No. 7,516,770 discloses a rubber door assembly that allows the rubber door to release from guide tracks and then be reinserted into the guide tracks after it is released. Rubber doors are not affected by smaller impacts since the rubber is flexible and does not dent like an aluminum door. Additionally, with larger impacts, the rubber door can flex and absorb a fair amount of the impact. Still further, if the impact is severe enough, the rubber door of the '770 patent is stated to be capable of release from the tracks to avoid damage to the tracks or the building structure.

The door assembly of the '770 patent has specially designed guides which are received within specially designed extruded aluminum tracks. The disclosure states that the tracks are flexible and are able to open or expand outwardly to allow the guides to be released. It is further disclosed that the guides can be reinserted into the extruded aluminum tracks if they are inadvertently released. The '770 patent further discloses that the guides have a generally concave head which mates with a generally convex surface in the aluminum tracks.

One of the problems with the door assembly of the '770 patent is the cost to manufacture the specially designed tracks and the additional cost in installing the tracks in a rollup door assembly. Still further, even though the aluminum tracks of the '770 patent are disclosed as being flexible and able to open to release the door guides, aluminum has a tendency to crack or break when it is plastically deformed, that is when the stress on the aluminum surpasses its yield point. With a large impact, the aluminum tracks could surpass their yield point and crack or break requiring replacement.

It is desirable to provide a rubber rollup door having all the benefits of rubber over aluminum, but still be relatively inexpensive to manufacture and install and have a superior release system that does not require replacement as a result of impacts.

### SUMMARY OF THE INVENTION

In general terms, the present invention provides a low cost highly dependable roll up door assembly that resists impacts and allows for quick and easy reinsertion of the door into the guide tracks if the door is removed from the tracks.

The door of the present invention can be released from the tracks and reinserted into the tracks without damage. In most instances, the door can be reinserted into the tracks by raising the door and re-inserting the locks into the track and then lowering the door.

The door assembly is low cost. The tracks are made of relatively inexpensive metal c-shaped channels, such as steel, that are connected together to from the track. One edge of each channel is spaced from an adjacent edge of the other channel to form the longitudinal opening which receives the rubber door. In one embodiment, the edges of the metal track which define the opening are covered by plastic guide rails that can easily snap off in the event the door is impacted to release the locks from the track. The guide rails can then be snapped back on the edges to reset the door.

In another embodiment, the opposed edges of the c shaped channels are bent inwardly to form a generally u-shaped guide rail that retains the locks within the track but allows the locks to be released upon impact. This further embodiment is much less expensive to manufacture than the extruded aluminum tracks of the '770 patent and is much less susceptible to breakage.

The roll up rubber door assembly of the present invention includes a rubber door having a front face and rear face and longitudinally extending opposed sides. Opposed tracks are mounted vertically at a spaced distance from each other, with each of the tracks having an elongated body portion defining an interior cavity and a vertically extending opening. The tracks have opposed edges that define the opening.

In one embodiment of the invention, a guide rail is snapped over each respective one of the edges of the track. The guide rail is generally square in cross-section and has an elongated slot that snaps over the edge.

In a further embodiment, the opposed edges are generally u-shaped in cross section to form generally smooth opposing faces. These faces act as cam surfaces to allow the locks to cam out of the track in the event of impact with the door.

Locks are mounted along the opposed sides of the rubber door and each lock has a head portion and a base portion. The base portion of each of the locks is attached to one of the opposed sides of the rubber door. The locks are operatively mounted within the tracks, with the head portion of lock being positioned within the cavity with the head portion and the body portion engaging the guide rails.

In this way, the locks are adapted to release from the tracks in the event of impact with the rubber door. The locks are adapted to pull through the edges without damage to the tracks.

The tracks of the present invention include two generally c-shaped channels with each having first and second flanges. The first flanges of each channel are joined and the second flanges are spaced from one another to define the opening.

The head portion of one of the embodiments of the locks of the present invention protrudes from a base and has five exposed surfaces, one of the surfaces extends generally parallel to the base and the remaining four surfaces extending at generally right angles to the base.

In another embodiment, head portion of the locks includes a sixth exposed surface extending at an acute angle between the surface extending generally parallel to the base and one of the four remaining surfaces, the sixth exposed surface creating a cam surface to facilitate release of the lock from the track.

These and other features and advantages of this invention will become more apparent to those skilled in the art from the detailed description of a preferred embodiment. The drawings that accompany the detailed description are described below.

### BRIEF DESCRIPTION OF THE DRAWINGS

FIG. 1 is a perspective view of the roll up door of the present invention.

FIG. 2, is a front view of the roll up door of the present invention.

FIG. 3 is a perspective view of the motor and shaft for opening and closing the roll up door of the present invention.

FIG. 4 is a cutaway view of the first embodiment of the track and lock of the present invention.

FIG. 5 is a cutaway view of the second embodiment of the track and lock of the present invention.

FIG. 6 is a perspective view of the first embodiment of the lock of the present invention connected to a door.

FIG. 7 is a perspective view of the first embodiment of the lock of the present invention.

FIG. 8 is a perspective view of the second embodiment of the lock of the present invention.

### DETAILED DESCRIPTION OF A PREFERRED EMBODIMENT

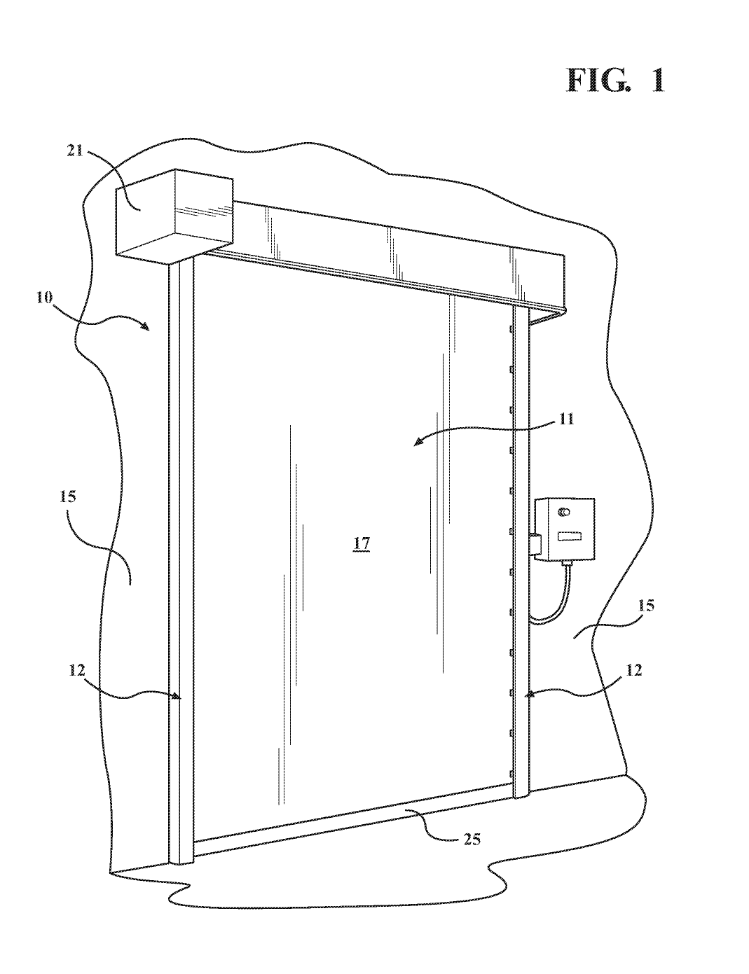

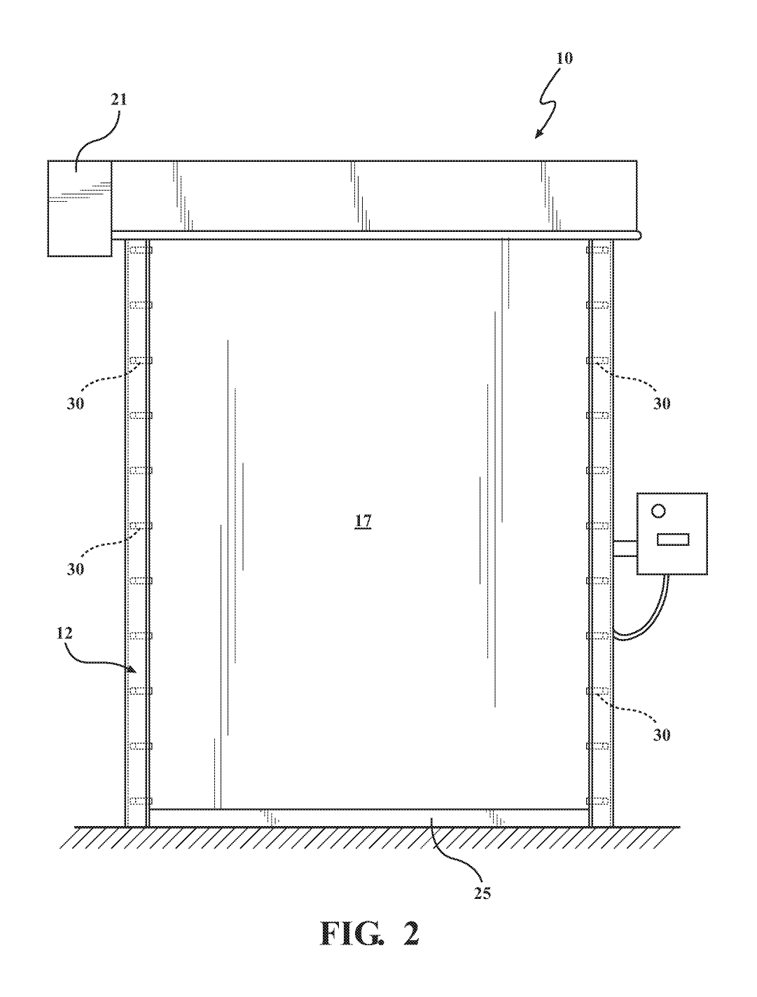

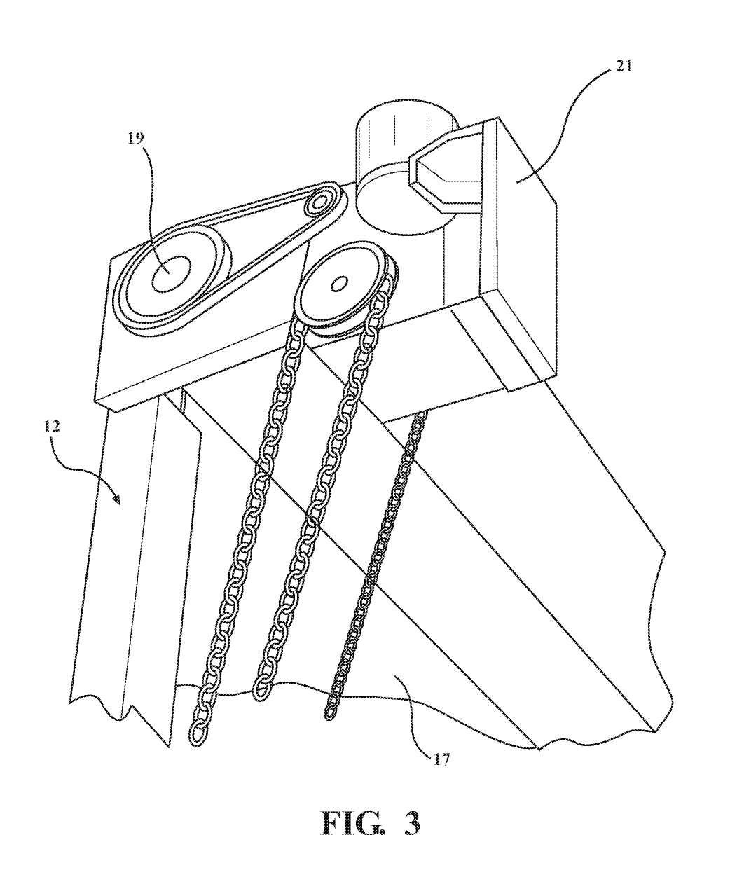

FIG. 1 generally illustrates the roll up door assembly 10 of the present invention. As illustrated, an opening 11 has sidewalls 15 with each sidewall having a door track assembly 12 mounted to it. A flexible door 17 is operatively mounted within the opposed door track assemblies 12 and can open and close the opening 11 by moving up and down the side track assemblies 12. The flexible doors 17 of the disclosed invention are typically made of rubber.

The flexible door 17 is wound and unwound upon a shaft 19 to open and close the door. The shaft 19 is either rotated by a motor and gear assembly 21 which can be a chain drive as illustrated or a direct drill assembly or by hand through the use of for example a pull chain. A bottom section or bar 25 is typically mounted to the bottom of the door 17 to assist in unwinding it. The bottom section 25 is relatively heavy when compared to the door 17 to assist in closing the door 17 and holding the door in the closed position. In the same example shown, the bottom bar 25 is a one piece extruded aluminum bar, but could also be several pieces of metal, aluminum etc.

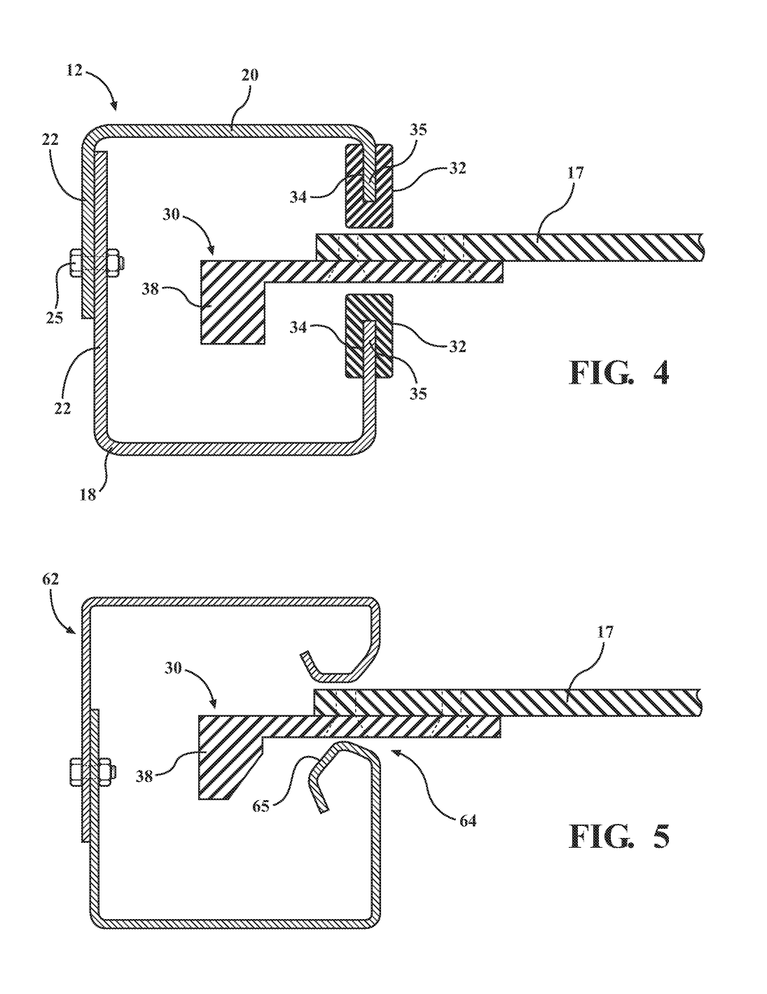

One example of the door track 12 is illustrated in FIG. 4. The track 12 has two c-shaped channels 18 and 20 joined at abutting flanges 22 to define an opening 26 between the spaced flanges 27. In this embodiment, the flanges 22 are joined by a bolt 25.

The flexible door 17 is released from the track 12 if it is inadvertently hit by something, like a vehicle. The door 17 releases from the track 12 to avoid damage to the door 17, track 12 or the building to which the track 12 is attached. To allow release, the door 17 has a series of locks 30 attached along the edge of the door 17. The locks 30 engage the track 12 and guide the door 17 up and down the track 12. If the door 17 is hit, the locks 30 snap out of the track 12. Once out, the locks 30 can be reinserted into the track 12. For example, reinsertion can be done manually, or by raising the door 17 to the top and then lowering it to reinsert the locks 30 into the track 12.

In order to allow efficient quick release without damage to the door 17 or the track 12, the shape of the lock 30 is important. A large impact against the door will force the door away from the opening 11 and pull one or more of the locks 30 from the track. In this way, the track and locks 30 are not damaged.

Guide strips or rails 32 facilitate release of the locks and smoother consistent operation of the door 17. As shown, the disclosed rails 32 are generally square in profile and have a slot 34 that is snapped over the facing edges 35 of the track 12. In this embodiment, the track 12 is made of steel. With the use of rails 32, if the doors 17 are impacted, the rails 32 can release from the tracks 12 facilitating release of the locks 30.

As disclosed, the locks 30 and rails 32 are made of plastic. The shape of the locks 30 ensure engagement of the locks 30 with the rails 32 and no engagement between the door 17 and the track 12 reducing wear upon the door 17 that would normally result from engagement of the door or locks with the metal track 12.

In FIG. 5, a further example of a track 62 is illustrated. In this embodiment, the opening 64 is formed by bending the edges of the opening into a generally u-shaped configuration to create a smooth sided reduced opening for retaining the locks 30 within the track 62. In this embodiment, the track 62 is preferably made of thin steel or other relatively flexible metal to allow the track 62 to flex in the event the door 17 is impacted. The opening includes an angled wall 65 that acts as a cam surface to allow release of the locks 30 in the event of impact.

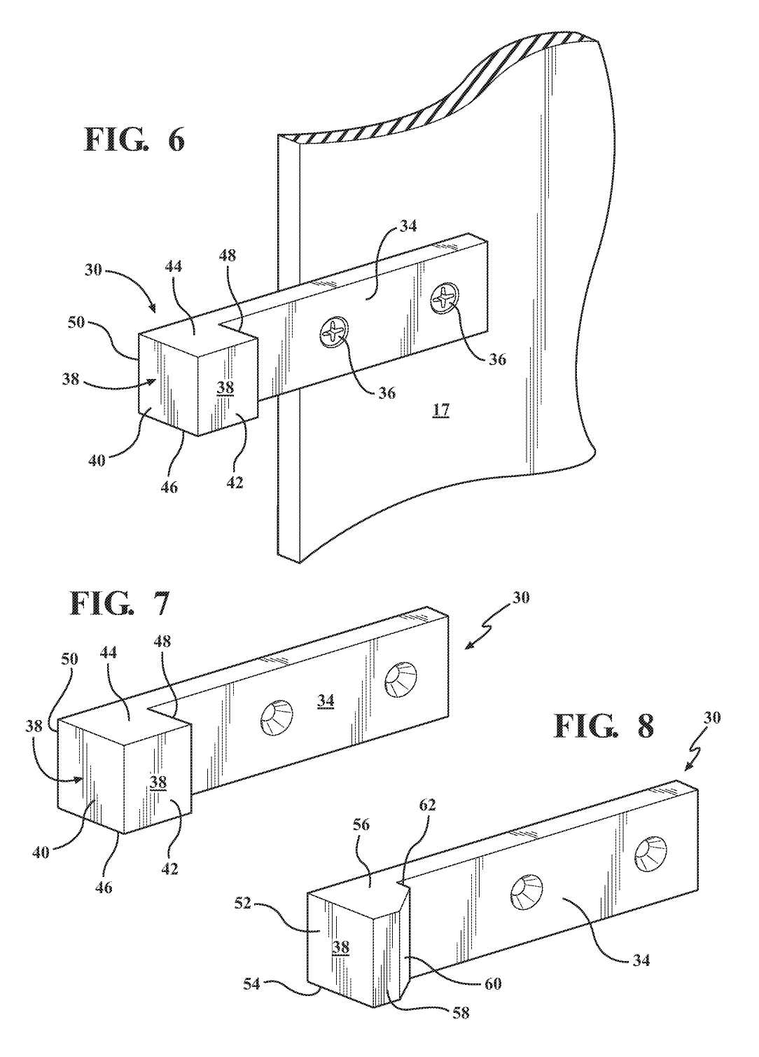

In FIGS. 6 and 7, a first embodiment of the lock 30 is illustrated. The lock 30 has a base 34 with holes for receipt of fasteners 36 to fasten the lock 30 to the door 17. The lock 30 also includes a head portion 38. In this embodiment, the head portion 38 is a parallelepiped having sides 40, 42, 44, 46, 48 and 50. The generally square shape of head 38 provides strong retention of the head 38 within track 12. With the head 38 sized for the track 12 and guide 24, the optimal amount of tension and release upon impact can be obtained.

In FIG. 8, a second embodiment of the lock 30 is illustrated having a six-sided. In this embodiment, there are sides 52, 54, 56, 58, 60, and 62. As illustrated, side 60 is angled with respect to sides 58 and 62. The angled side 60 facilitates the release of the lock 30 upon impact of the door 17. The side 60 acts as a cam surface to normally hold the door 17 in the track 12, but allow easy release of the door 17 upon impact. It should be appreciated by one of ordinary skill in the art that either lock will work with either track of the present invention.

In a still further embodiment of the present invention, the door 17 is preferably made from a single piece of rubber. Rubber doors are commonly used, but they are formed from at least two and sometimes several pieces of rubber. The edges of the pieces of rubber are cut at an angle and then the two angled edges are glued together. This is a very time consuming process and relatively expensive process. To save time, money and to eliminate any issues with the glued edges, one option for the present invention is to use a single piece of rubber cut to the proper size of the opening without any glued seams.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

We claim:

1. A roll up flexible door assembly comprising:
a door having a front face and rear face and longitudinally extending opposed sides;
opposed tracks mounted vertically at a spaced distance from one another, each of said tracks having an elongated body portion defining an interior cavity and a vertically extending opening, said tracks having opposed edges defining said opening;
a pair of guide rails having a generally square profile and a slot, said slot being snapped over a respective one of said edges of said track;
locks mounted along the opposed sides of said door; each of said locks having a head portion and a base portion, said base portion of each of said locks is attached to one of said opposed sides of said door, said locks being operatively mounted within said tracks, said head portion of said locks being positioned within said cavity with said head portion and said body portion being adjacent said guide rails;
whereby said locks are adapted to release from said tracks in the event of impact with said door, said locks being adapted to pull through or snap off said guide rails without damage to said tracks.

2. The door assembly of claim 1, wherein said guide rails can release upon impact with said door to facilitate the release of said locks.

3. The door assembly of claim 1, wherein said locks and guide rails are plastic.

4. The door assembly of claim 1, wherein said track is metal.

5. The door assembly of claim 1, wherein said track includes two generally c-shaped channels each having first and second flanges, said first flanges of each channel being joined and said second flanges being spaced from one another to define said opening.

6. The flexible door assembly of claim 1, further including a shaft mounted to a drive mechanism, said flexible door being attached to said shaft such that said flexible door is rolled upon said shaft and unrolled from said shaft, said drive mechanism driving said shaft.

7. The door assembly of claim 1, wherein said head portion of each of said locks protrudes from said base and has five exposed surfaces, one of said surfaces extending generally parallel to said base and the remaining four surfaces extending at generally right angles to said base.

8. The door of claim 7, wherein said head portion of said locks includes a sixth exposed surface extending at an acute angle between said one surface extending generally parallel to said base and one of said four remaining surfaces, said sixth exposed surface creating a cam surface to facilitate release of said lock from said track.

9. The door assembly of claim 1, wherein said head portion of each of said locks protrudes from said base and has six exposed surfaces, one of said surfaces extending generally parallel to said base, four surfaces extending at generally right angles to said base and a sixth surface extending at an acute angle between said surface extending generally parallel to said base and one of said four surfaces extending at generally right angles to said base.

10. A roll up door assembly comprising:
a door having a front face and rear face and longitudinally extending opposed sides;
opposed tracks mounted vertically at a spaced distance from one another, each of said tracks having an elongated body portion defining an interior cavity and a vertically extending opening, each of said tracks having opposed edges defining said opening, said opposed edges being generally u-shaped in cross section to form generally smooth opposing faces;
locks mounted along the opposed sides of said door; each of said locks having a head portion and a base portion, said base portion of each of said locks is attached to one of said opposed sides of said door, said locks being operatively mounted within said tracks, said head portion of said locks being positioned within said cavity with said head portion and said body portion engaging said opposed edges;
whereby said locks are adapted to release from said tracks in the event of impact with said door, said locks being adapted to pull through said edges without damage to said tracks.

11. The door assembly of claim 10, wherein said opposed edges flex upon impact with said door to facilitate the release of said locks.

12. The door assembly of claim 10, wherein said locks are plastic.

13. The door assembly of claim 10, wherein said track is metal.

14. The door assembly of claim 10, wherein said track includes two generally c-shaped channels each having first and second flanges, said first flanges of each channel being joined and said second flanges being spaced from one another to define said opening.

15. The flexible door assembly of claim 10, further including a shaft mounted to a drive mechanism, said flexible door being attached to said shaft such that said flexible door is rolled upon said shaft and unrolled from said shaft, said drive mechanism driving said shaft.

16. The door assembly of claim 10, wherein said head portion of each of said locks protrudes from said base and has five exposed surfaces, one of said surfaces extending generally parallel to said base and the remaining four surfaces extending at generally right angles to said base.

17. The door of claim 16, wherein said head portion of said locks includes a sixth exposed surface extending at an acute angle between said one surface extending generally parallel to said base and one of said four remaining surfaces, said sixth exposed surface creating a cam surface to facilitate release of said lock from said track.

18. The door assembly of claim 10, wherein said head portion of each of said locks protrudes from said base and has six exposed surfaces, one of said surfaces extending generally parallel to said base, four surfaces extending at generally right angles to said base and a sixth surface extending at an acute angle between said surface extending generally parallel to said base and one of said four surfaces extending at generally right angles to said base.

19. The door assembly of claim 10, wherein said door is constructed of a single continuous piece of rubber.
